(19) United States
(12) Patent Application Publication
(10) Pub. No.: US 2026/0300330 A1
(43) Pub. Date: Oct. 1, 2026

(54) INFORMATION PROCESSING APPARATUS AND INFORMATION PROCESSING METHOD

(71) Applicant: Hitachi, Ltd., Tokyo (JP)

(72) Inventors: Daiki TAKAO, Tokyo (JP); Yoshiki KUROKAWA, Tokyo (JP); Norifumi NISHIKAWA, Tokyo (JP); Kazuhiko MOGI, Tokyo (JP)

(21) Appl. No.: 19/308,385

(22) Filed: Aug. 25, 2025

(30) Foreign Application Priority Data
Mar. 31, 2025 (JP) 2025-058446

(51) Int. Cl. G06F 16/31; G06F 16/334

(52) U.S. Cl. CPC G06F 16/313; G06F 16/3347

(57) ABSTRACT

In an information processing apparatus, data items that satisfy search conditions for various attribute values and are close to a query vector are acquired at high speed and with high accuracy. The information processing apparatus calculates a first scale representing closeness between a vectorized unstructured data item associated with a first data item and a vectorized unstructured data item associated with a second data item, and calculates a second scale representing closeness between structured data items associated with the first data item and structured data items associated with the second data item. Then, the information processing apparatus calculates a first evaluation indicator representing closeness between the first data item and the second data item based on the first scale and the second scale, and builds an index by combining the first data item and the second data item according to the first evaluation indicator.

### CROSS REFENCES TO RELATED APPLICATION

This application claims priority based on Japanese patent applications, No. 2025-58446 filed on Mar. 31, 2025, the entire contents of which are incorporated herein by reference.

### BACKGROUND OF THE INVENTION

### Background

The present invention relates to an information processing apparatus and an information processing method.

### Description of the Related Art

With the development of generative AI technology and the like, there has recently been a need for a method of acquiring desired data items from a large number of vector data items at high speed and with high accuracy. In this regard, there have been proposed many techniques, including Patent Literature 1, for acquiring desired data items from multidimensional vector data items based on vector similarity.

Further, as disclosed in Patent Literature 2, there has been a technique for facilitating conjunctive filtering in an information search system that searches for data items represented as vectors. The technique disclosed in Patent Literature 2 concatenates, for each data item, a vectorized data item body with an attribute value for each vectorized data item to form an enhanced multidimensional vector. Further, for a query for a data search in an information search system, a vectorized query body is concatenated with filtering parameters received together with each query and vectorized, thereby forming an enhanced multidimensional query vector. This multidimensional query vector is used to perform an approximate k-nearest neighbor search that identifies data items relevant to the query and having attribute values satisfying the filtering parameters.

### CITATION LIST

### Patent Literature

Patent Literature 1: Japanese Patent Laid-Open No. 2020-9333
Patent Literature 2: U.S. Pat. No. 11,704,312

However, when extracting data items satisfying search conditions for attribute values associated with a multidimensional vector, the above technique disclosed in Patent Literature 1 first extracts similar data items in consideration of only similarity between multidimensional vectors, and then determines whether the conditions for the attribute values are satisfied. For this reason, it has a problem of a decrease in search speed due to data items being extracted many times until data items satisfying the search conditions are obtained.

Further, the above technique disclosed in Patent Literature 2 can simultaneously evaluate the similarity between multidimensional vectors and the satisfaction of conditions for attribute values. However, it has a problem that since a categorical attribute with a cardinality of cr is converted to a multidimensional vector in (cr-1) dimensions, the number of dimensions of the multidimensional vector after conversion becomes enormous, resulting in a decrease in processing speed and processing accuracy.

Further, the above technique disclosed in Patent Literature 2 has a problem that it cannot be applied to attributes with a large cardinality and numerical attributes such as ratio scales, which limits data types and search queries that it can deal with.

The present invention has been made in view of the above circumstances, and one object thereof is to acquire data items that satisfy search conditions for various attribute values and are close to a query vector at high speed and with high accuracy in an information processing apparatus.

### SUMMARY

In order to achieve the above object, as one aspect, the present invention is characterized in that, in an information processing apparatus building an index including one or more data items with each of which a vectorized unstructured data item and one or more structured data items are associated, a processor of the information processing apparatus: calculates a first scale representing closeness between the vectorized unstructured data item associated with a first data item of the one or more data items and the vectorized unstructured data item associated with a second data item of the one or more data items; calculates a second scale representing closeness between the one or more structured data items associated with the first data item and the one or more structured data items associated with the second data item; calculates a first evaluation indicator representing closeness between the first data item and the second data item based on the first scale and the second scale; and builds the index by combining the first data item and the second data item according to the first evaluation indicator.

Further, in order to achieve the above object, as another aspect, the present invention is characterized in that, in an information processing apparatus storing an index including one or more data items with each of which a vectorized unstructured data item and one or more structured data items are associated, a processor of the information processing apparatus: receives an input including a query vector that gives a condition that the vectorized unstructured data item should satisfy and a search condition that gives a condition that the one or more structured data items should satisfy; calculates a first scale representing closeness between the query vector and the vectorized unstructured data item associated with one of one or more data items in the index that are the one or more data items included in the index; calculates a second scale representing closeness between the search condition and the one or more structured data items associated with the data item in the index; calculates a second evaluation indicator representing closeness between the first scale and the second scale; and extracts one or more of the one or more data items in the index satisfying the query vector and the search condition according to the second evaluation indicator.

According to the present invention, for example, it is possible to acquire data items that satisfy search conditions for various attribute values and are close to a query vector at high speed and with high accuracy in an information processing apparatus. The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating a configuration of an information processing system according to an embodiment 1;

FIG. 2 is a diagram illustrating the structure of a table according to the embodiment 1;

FIG. 3 is a diagram illustrating the structure of a graph-based index according to the embodiment 1;

FIG. 4 is a diagram illustrating the logical structure of the graph-based index according to the embodiment 1;

FIG. 5 is an explanatory diagram of details of elements of a data processing unit according to the embodiment 1;

FIG. 6 is a flowchart illustrating an indexing process according to the embodiment 1;

FIG. 7 is a flowchart illustrating a process for calculating an evaluation indicator in indexing according to the embodiment 1;

FIG. 8 is a flowchart illustrating an index search process according to the embodiment 1;

FIG. 9 is a flowchart illustrating a process for calculating an evaluation indicator in index searching according to the embodiment 1;

FIG. 10 is a flowchart illustrating an indexing process according to an embodiment 2;

FIG. 11 is a flowchart illustrating a conventional indexing process according to the embodiment 2;

FIG. 12 is a flowchart illustrating an index search process according to the embodiment 2;

FIG. 13 is a flowchart illustrating an extended index search process according to the embodiment 2;

FIG. 14 is a flowchart illustrating a conventional index search process according to the embodiment 2;

FIG. 15 is a diagram illustrating an example of a graph-based index (HNSW) having a hierarchical structure; and

FIG. 16 is a flowchart illustrating a weight optimization process according to an embodiment 3.

### DETAILED DESCRIPTION OF THE INVENTION

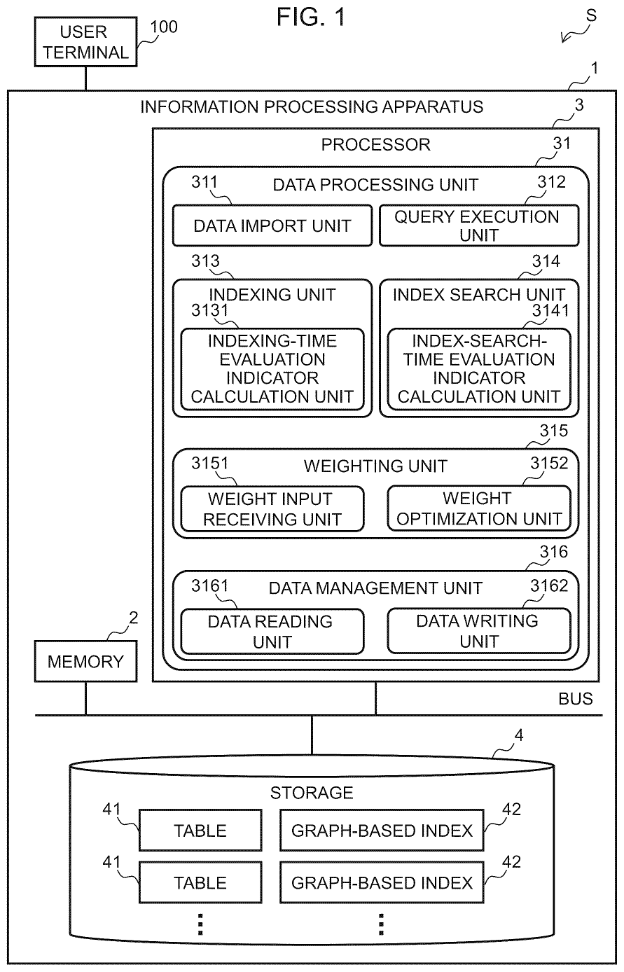

Embodiments according to the present invention will be described in detail below with reference to FIGS. 1-16. Note that the present invention is not limited by the following embodiments. In the following description, the same components and processes are given the same number, and duplicate description will be omitted.

### Embodiment 1

### (Configuration of Information Processing System S According to Embodiment 1)

FIG. 1 is a diagram illustrating a configuration of an information processing system S according to an embodiment. The information processing system S includes an information processing apparatus 1 and a user terminal 100. The user terminal 100 transmits queries including requests for indexing and index searching to the information processing apparatus 1.

The information processing apparatus 1 includes a memory 2, a processor 3, and a storage 4. The memory 2 is a volatile main storage apparatus such as a dynamic random access memory (DRAM). The processor 3 is an arithmetic processing unit such as a central processing unit (CPU). The storage 4 is a non-volatile external storage apparatus such as a solid state drive (SSD) or a disk array composed of SSDs.

The processor 3 has a data processing unit 31 implemented by executing a program in cooperation with the memory 2. The storage 4 stores a table 41 and a graph-based index 42. The table 41 and the graph-based index 42 are loaded into the memory 2 when processed by the data processing unit 31.

The data processing unit 31 includes a data import unit 311, a query execution unit 312, an indexing unit 313, an index search unit 314, a weighting unit 315, and a data management unit 316. The indexing unit 313 includes an indexing-time evaluation indicator calculation unit 3131. The index search unit 314 includes an index-search-time evaluation indicator calculation unit 3141. The weighting unit 315 includes a weight input receiving unit 3151 and a weight optimization unit 3152. The data management unit 316 includes a data reading unit 3161 and a data writing unit 3162.

The data import unit 311 accepts a query including input data and index information from the user terminal 100, and creates a table 41. The data import unit 311 requests the data management unit 316 to perform a data writing process and requests the indexing unit 313 to perform an indexing process.

The query execution unit 312 accepts a query of an index search request from the user terminal 100, and requests the data management unit 316 to perform a data reading process based on an index search result obtained from the index search unit 314. The query execution unit 312 outputs data items matching the query of the index search request to the user terminal 100 as a query result.

The indexing unit 313 includes an indexing-time evaluation indicator calculation unit 3131, requests the data management unit 316 to perform a data reading process and a data writing process based on an indexing request from the data import unit 311, and builds a graph-based index 42.

The index search unit 314 includes an index-search-time evaluation indicator calculation unit 3141, requests the data management unit 316 to perform a data reading process based on an index search request from the query execution unit 312, and searches the graph-based index 42.

The data management unit 316 includes a data reading unit 3161 and a data writing unit 3162, and reads data from and writes data to the memory 2 and the storage 4 based on a request from the data import unit 311, the query execution unit 312, the indexing unit 313, and the index search unit 314.

The indexing-time evaluation indicator calculation unit 3131 calculates an evaluation indicator related to similarity between any data items based on similarity between attribute values and a logical distance on a vector space. This evaluation indicator makes it possible to build a graph-based index 42 such as having an edge between data items that have similar attribute values and have a short logical distance between vector data items.

The index-search-time evaluation indicator calculation unit 3141 calculates an evaluation indicator related to the appropriateness as a query result based on search conditions for the attribute values and the logical distance from a query vector on the vector space. Searching the graph-based index 42 based on this evaluation indicator allows extraction of a specified number of vector data items that match the search conditions for the attribute values and have a short logical distance from the query vector at high speed and with high accuracy.

The weighting unit 315 includes a weight input receiving unit 3151 and a weight optimization unit 3152, and provides the value of a weight of each element used for calculating the evaluation indicator to the indexing-time evaluation indicator calculation unit 3131 and the index-search-time evaluation indicator calculation unit 3141.

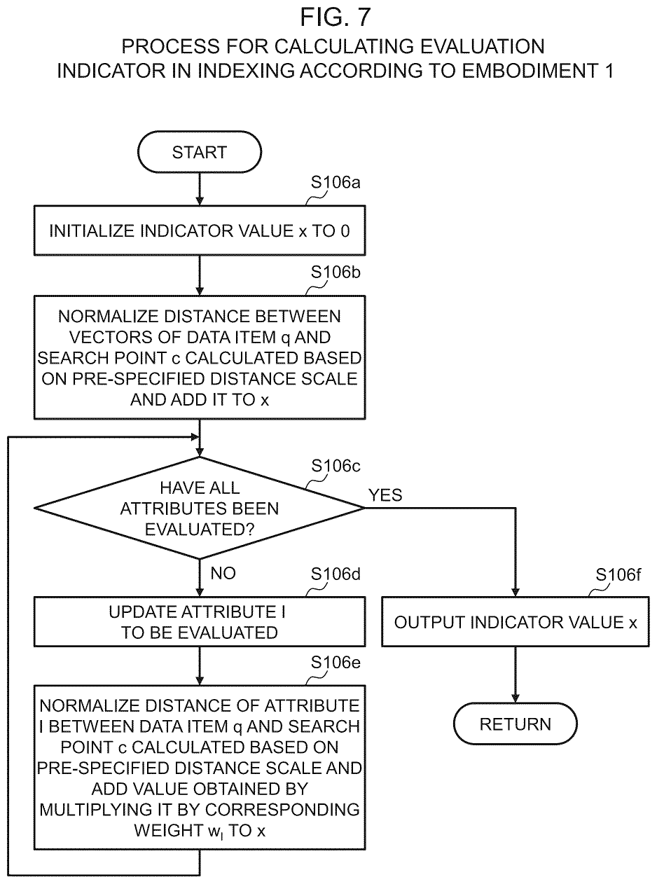

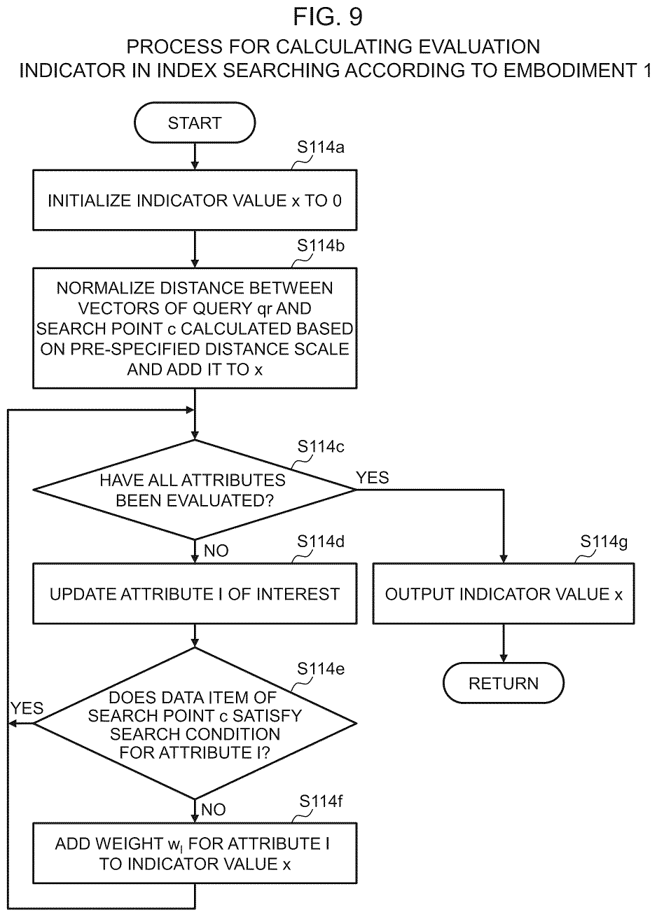

The weight input receiving unit 3151 receives input of a weight w_I specified by a user. The weight optimization unit 3152 automatically optimizes the weight w_I when the weight w_I used in step S106e (FIG. 7) and step S114f (FIG. 9) is not specified by the user.

The data reading unit 3161 reads the table 41 and the graph-based index 42 from the memory 2 and the storage 4. The data writing unit 3162 writes the table 41 and the graph-based index 42 to the memory 2 and the storage 4.

The table 41 is main data to be managed in the data processing unit 31, and includes a plurality of vector data items and attribute values. Note that these data items are stored in any row-oriented or column-oriented organization, but the file format when they are stored may be the CSV format, the parquet format, or the like, and is not particularly limited.

The graph-based index 42 is an index structure for extracting data items that match search conditions given by the user from the table 41 at high speed and with high accuracy. The graph-based index 42 is represented as a graph structure in which an edge is created between data items in the table 41 having similar attribute values and vector data items according to the evaluation indicator described later. In this embodiment, the type of the graph-based index structure is assumed to be, for example, NSW, HNSW, or SNG, but is not limited to those described before. Note that the format in managing the graph structure is not limited, and may be, for example, an adjacent graph format or a table format.

### (Table 41 According to Embodiment 1)

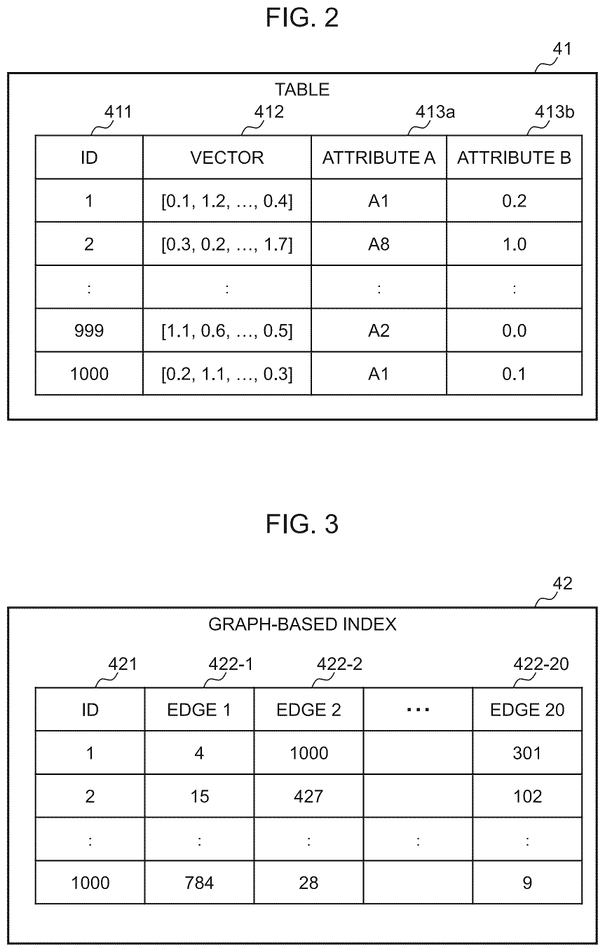

FIG. 2 is a diagram illustrating a configuration of the table 41 according to the embodiment 1. The table 41 has columns of an ID 411, a vector 412, and attributes 413.

The ID 411 is identification information for uniquely identifying data of the vector 412 and the values of the attributes 413 associated therewith. The vector 412 has a value of multidimensional vector data. The attributes 413 represent attribute values associated with the corresponding vector 412.

Note that as the attributes 413, FIG. 2 shows two types of attributes 413: an attribute 413a representing an attribute A that is a categorical attribute and an attribute 413b representing an attribute B that is a numerical attribute, but the number of attributes and the data types of attributes are not limited. Further, although FIG. 2 shows a simple row-oriented table structure as an example, the present invention is not limited thereto, but can be applied to other structures such as column-oriented structures, and various organizations such as partitioning and striping.

### (Graph-Based Index 42 According to Embodiment 1)

FIG. 3 is a diagram illustrating a configuration of the graph-based index 42 according to the embodiment 1. FIG. 3 shows the graph-based index 42 for the example of the table 41 shown in FIG. 2. The graph-based index 42 has an ID 421 and edges 422.

The ID 421 is common to the ID 411 in the table 41, and represents to which vector data item each node in the graph-based index 42 corresponds. The edges 422 represent edge information in the graph-based index 42, and, for example, FIG. 2 shows that an edge for transitioning from a node corresponding to an ID of “1” to a node corresponding to a data item with an ID of “4” is created.

This embodiment determines nodes for which edges are to be created based on the evaluation indicator calculated by the indexing-time evaluation indicator calculation unit 3131, thereby making it possible to preferentially create an edge between data items having similar attribute values and having a short logical distance between vector data items.

Further, although FIG. 3 shows a simple row-oriented table structure as an example, the present invention is not limited thereto, but can be applied to any data format including file formats and page formats.

### (Logical Structure of Graph-Based Index 42 According to Embodiment 1)

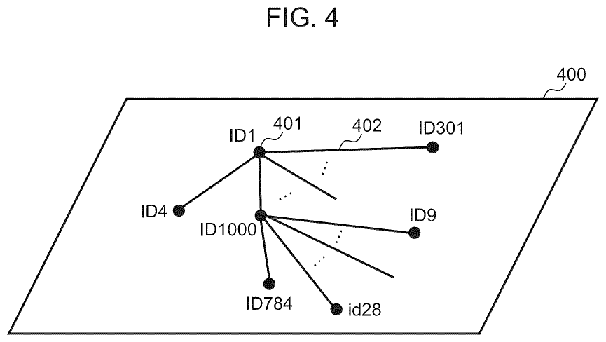

FIG. 4 is a diagram illustrating the logical structure of the graph-based index 42 according to the embodiment 1. The graph index 42 can be represented as a set of nodes 401 and edges 402 mapped on a vector space 400.

The vector space 400 is a vector space corresponding to vector data items provided from the user terminal 100 as input, and all data items in the table 41 shown in FIG. 2 are mapped onto this space.

The node 401 has a one-to-one correspondence with the data item in the table 41, and has the attribute values of the attributes 413 in addition to the vector 412 (the vector data item). For example, the node 401 with an ID of “1” has a value of “A1” as the attribute 413a (the attribute A) and a value of “0.2” as the attribute 413b (the attribute B).

An edge 402 indicates that a transition from one node 401 to another node 401 in the graph is possible. An edge 402 is created between nodes 401 that are determined to have similar attribute values and vector data items according to the evaluation indicator described later. For example, edges 402 are created from the node 401 with an ID of “1” to a total of twenty nodes 401 including one with an ID of “1000”, which has a short distance between vector data items and similar values of the attributes 413a (the attribute A) and the attributes 413b (the attribute B). In the index search process, it is possible to transition to these nodes 401 to which edges 402 are created from the node 401 with an ID of “1”.

### (Data Processing Unit 31 According to Embodiment 1)

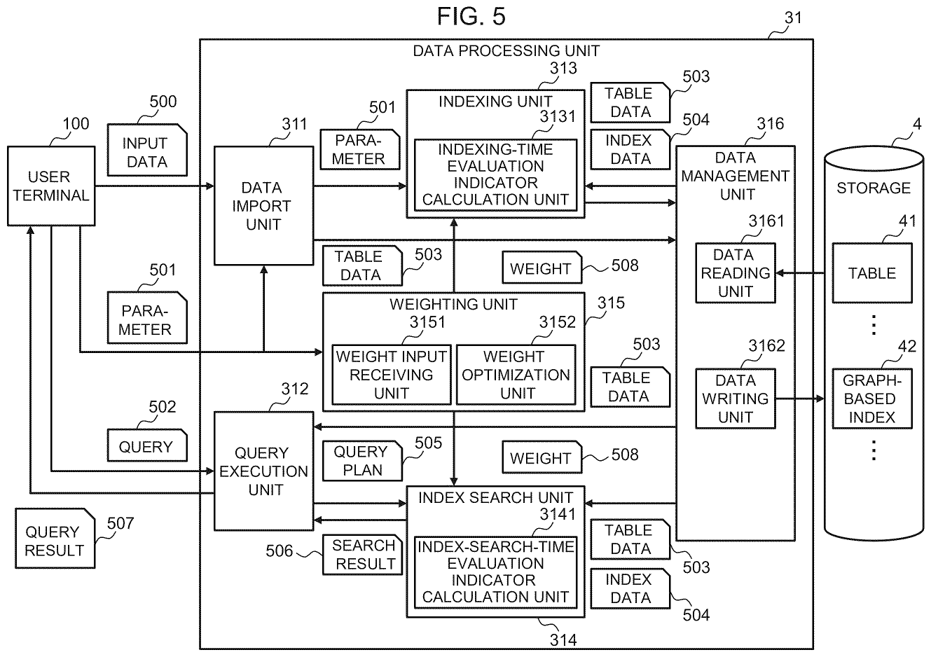

FIG. 5 is an explanatory diagram of details of elements of the data processing unit 31 according to the embodiment 1.

In FIG. 5, data related to the processing in the data processing unit 31 includes input data 500, parameters 501, a query 502, table data 503, index data 504, a query plan 505, an index search result 506, and a query result 507.

The input data 500 is data given from the user terminal 100 to the data processing unit 31 as input, and has vector data items and any number of attribute values. Note that the file format of the input data 500 is CSV, but is not limited thereto.

The parameters 501 are parameter values related to indexing given from the user terminal 100 to the data processing unit 31 as input, and are passed from the data import unit 311 to the indexing unit 313. The input form of the parameters 501 such as those using the command line or via a file does not matter, and it is possible to specify not only information related to the graph configuration such as the number of edges of the index, but also distance scales for vector data items and attributes necessary for calculating the evaluation indicators, and weights in adding the values of the distance scales.

Here, any distance scale such as the Euclidean distance or the cosine distance is selected for vector data items, and any distance scale suitable for the level of measurement for each data item is selected for each attribute. Further, the weight in adding the value of each distance scale indicates that the larger the value, the more preferentially the value of the distance scale is evaluated. When weights are input from the user terminal 100, the weighting unit 315 receives them via the weight input receiving unit 3151, and when no weights are input, the weight optimization unit 3152 automatically determines the weights. Specific examples of the automatic weight determination method will be described later.

The query 502 is a query given from the user terminal 100 to the data processing unit 31, and includes information necessary for the neighbor search process, such as search conditions for the attributes, a query vector, and the number of data items to be acquired. Further, other data processes may be specified, such as an aggregation process for vector data items obtained as a result of a neighbor search, and a joining process with other table data.

The table data 503 is built by the data import unit 311 based on the input data 500, and is stored in the storage 4 via the data management unit 316.

The index data 504 is built by the indexing unit 313 and is stored in the storage 4 via the data management unit 316. The index data 504 is updated by the indexing unit 313 adding new nodes and edges based on the table data 503 acquired from the data management unit 316 and the index data 504 that has been built so far.

The query plan 505 is data related to an index search in the query 502 interpreted by the query execution unit 312 and the optimized execution plan, and includes information on search conditions for the attributes, the query vector, and the number of data items to be acquired.

The search result 506 is a result obtained by the index search unit 314 searching the graph-based index represented with the table data 503 and the index data 504 acquired from the data management unit 116 based on the query plan 505 given by the query execution unit 312. The search result 506 has a specified number of table data items 503 in order of shortness of the logical distance from the query vector among table data items 503 satisfying the search conditions for the attribute values.

The query result 507 is an output from the query execution unit 312 for the query 502 which is an input from the user terminal 100, and may be the search result 506 itself obtained from the index search unit 314. Alternatively, the query result 507 may be a result of performing a data process such as a joining process or an aggregation process with other table data 503 based on the search result 506.

A weight 508 is information necessary for calculating the evaluation indicators in the indexing-time evaluation indicator calculation unit 3131 and the index-search-time evaluation indicator calculation unit 3141. A value received by the weight input receiving unit 3151 from the weighting unit 315 or a value automatically determined by the weight optimization unit 3152 is passed as the weight 508.

The data management unit 316 manages the reading and writing of the table data 503 and the index data 504 from and to the storage 4 using the memory 2. This enables other processing units to transparently process data without being aware of the physical storage locations of these data.

### (Indexing Process According to Embodiment 1)

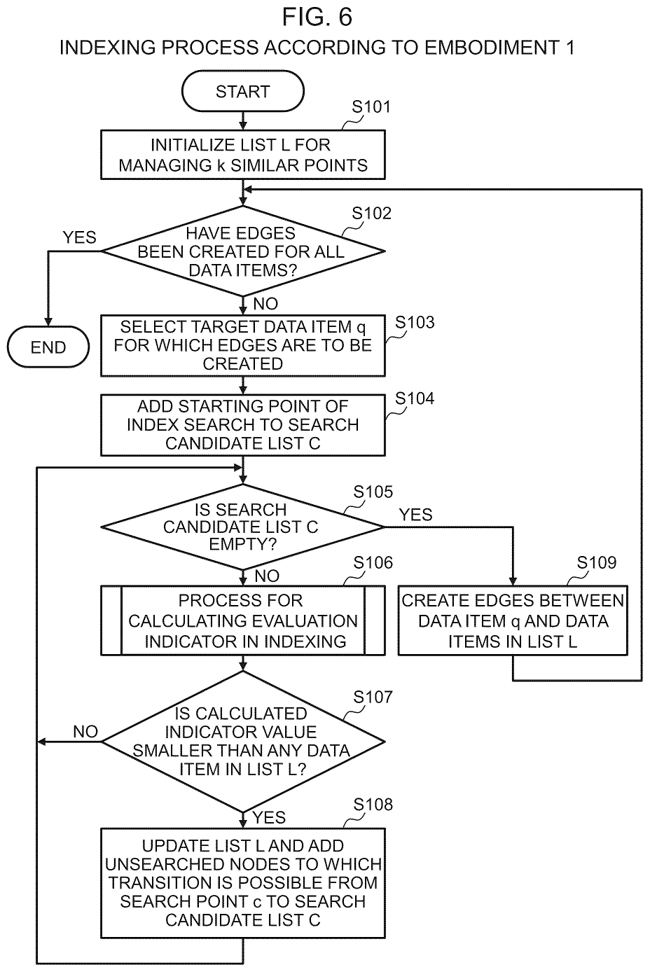

FIG. 6 is a flowchart illustrating an indexing process according to the embodiment 1. The indexing process according to the embodiment 1 is executed by the indexing unit 313 in response to receiving an indexing request via the user terminal 100.

Although the indexing process according to the embodiment 1 is assumed to employ navigable small world (NSW) and a search algorithm for NSW, this embodiment can also employ other index structures such as hierarchical navigable small world (HNSW) and search algorithms therefor.

First, in step S101, the indexing unit 313 initialize a list L for managing k similar points. However, the number k of elements in the list L is determined based on the upper limit of the number of edges given from the user terminal 100 as a parameter.

Next, in step S102, the indexing unit 313 determines whether edges have been created for all data items in the list L. When edges have been created for all data items (YES in step S102), the indexing unit 313 ends the indexing process. On the other hand, when edges have not been created for all data items (NO in step S102), the indexing unit 313 advances the process to step S103.

Next, in step S103, the indexing unit 313 selects a target data item q for which edges are to be created from among data items for which edges have not been created. The target data item q may be selected randomly or based on similarity of data items.

Next, in step S104, the indexing unit 313 adds a starting point of an index search to a search candidate list C. The search starting point may be either a data item first added to the search candidate list C or a data item located in the center of the vector space 400.

Next, in step S105, the indexing unit 313 determines whether the search candidate list C is empty. When the search candidate list C is not empty (NO in step S105), the indexing unit 313 advances the process to step S106. On the other hand, when the search candidate list C is empty (YES in step S105), the process is advanced to step S109.

In step S106, the indexing-time evaluation indicator calculation unit 3131 executes a process for calculating an evaluation indicator in indexing in which any data item is retrieved from the search candidate list C as a search point c (a first data item) and an evaluation indicator in indexing with the target data item q (a second data item) for which edges are to be created is calculated. Details of the process for calculating an evaluation indicator in indexing will be described later with reference to FIG. 7.

The search point c selected in step S106 may be either a data item first added to the search candidate list C or a randomly selected data item. However, considering the nature of the evaluation indicator in indexing that the higher the similarity between data items, the smaller the indicator value, preferentially selecting nodes to which a transition has been made from a node with a smaller indicator value allows exhaustive evaluation of data items similar to the target data item q at earlier timing. This makes it possible to shorten the indexing time, and also improve the quality as the graph-based index in that edges are more likely created between data items with high similarity.

Next, in step S107, the indexing unit 313 determines whether the indicator value of the search point c calculated in step S106 is smaller than the indicator value of any data item in the list L. When the indicator value of the search point c calculated in step S106 is smaller than the indicator value of any data item in the list L (YES in step S107), the indexing unit 313 advances the process to step S108. On the other hand, when the indicator value of the search point c calculated in step S106 is larger than the indicator value of any data item in the list L (NO in step S107), the indexing unit 313 returns the process to step S105.

In step S108, when the number of elements in the list L is less than k, the indexing unit 313 simply adds the search point c, and when the number of elements is k or more, the indexing unit 313 replaces the data item having the largest indicator value in the list L with the search point c. Then, the indexing unit 313 adds unsearched nodes to which a transition is possible from the search point c to the search candidate list C. Step S108 also allows searching for data items in the vicinity of the search point c. When step S108 is completed, the indexing unit 313 returns the process to step S105.

On the other hand, in step S109, since up to k data items similar to the search point c are stored in the list L, the indexing unit 313 creates edges between those data items and the search point c. The above process builds a graph-based index 42 by efficiently finding a target data item q having a small evaluation indicator and creating an edge between the target data item q and the search point c.

The indexing process described above builds an index, by, for example, combining a first data item with one or more second data items for which the degree of deviation of a first evaluation indicator based on the first data item from a reference value is ranked in a predetermined place or higher in ascending order in which the degrees of deviation are arranged in order from the smallest to the largest. Note that the reference value is the first evaluation indicator (the evaluation indicator in indexing) when the first data item is the same as a second data item.

Although conventional graph-based indexes for an approximate neighbor search of vector data items create edges based only on the distance between vectors, this embodiment considers not only the distance between vectors but also the similarity between attribute values using the evaluation indicator in indexing. Therefore, it is possible to build a graph-based index that has an edge between data items having not only a short distance between vectors but also high similarity between attribute values.

### (Process for Calculating Evaluation Indicator in Indexing According to Embodiment 1)

FIG. 7 is a flowchart illustrating the process for calculating an evaluation indicator in indexing according to the embodiment 1. The process for calculating an evaluation indicator in indexing is a process executed in step S106 (FIG. 6) of the indexing process.

First, in step S106a, the indexing-time evaluation indicator calculation unit 3131 initializes an indicator value x at 0. Next, in step S106b, the indexing-time evaluation indicator calculation unit 3131 calculates the distance between the vectors of the target data item q and the search point c selected by the indexing unit 313 based on a distance scale that is set from the user terminal 100 as a parameter. This distance is a first scale representing the closeness between vectorized unstructured data items (e.g., vectors) each associated with a respective one of the first data item and the second data item.

Then, the indexing-time evaluation indicator calculation unit 3131 normalizes the distance between the vectors of the target data item q and the search point c so that the minimum value is 0 and the maximum value is 1, and then adds it to the indicator value x.

Next, in step S106c, the indexing-time evaluation indicator calculation unit 3131 determines whether the similarities of the values of all attributes have been evaluated. When the similarities of the values of all attributes have not been evaluated (NO in step S106c), the indexing-time evaluation indicator calculation unit 3131 advances the process to step S106d. On the other hand, when the similarities of the values of all attributes have been evaluated (YES in step S106c), the indexing-time evaluation indicator calculation unit 3131 advances the process to step S106f.

In step S106d, the indexing-time evaluation indicator calculation unit 3131 selects one attribute I to be evaluated from unevaluated attributes. The order of selecting the attribute I here is not affected by the calculation result of the indicator value x.

Next, in step S106e, the indexing-time evaluation indicator calculation unit 3131 calculates the distance scale for the attribute I of the target data item q and the search point c selected in step S106b. This distance scale is a second scale that represents the closeness between structured data items (e.g., attributes) each associated with a respective one of the first data item and the second data item.

Then, the indexing-time evaluation indicator calculation unit 3131 normalizes the value of the distance scale for the attribute I of the target data item q and the search point c so that the minimum value is 0 and the maximum value is 1, and then adds a value obtained by multiplying it by a weight w_I corresponding to the attribute I to the indicator value x. The multiplied weight w_I will change the contribution of the attribute I to the indicator value x.

The weight w_I here indicates that the larger the value, the more preferentially the similarity of the attribute is evaluated, and a value passed from the weighting unit 315 is used. Since tuning this weight w_I changes the way edges are created, it affects not only the indexing time but also the processing accuracy and processing time during an index search. Further, the distance scale for the attribute I is specified in advance from the user terminal 100 as a parameter. For example, a binary value of a result of determining whether values match or mismatch is set for a categorical attribute, and a distance scale suitable for a level of measurement such as the Euclidean distance is set for an attribute of a ratio scale. When step S106e is completed, the indexing-time evaluation indicator calculation unit 3131 returns the process to step S106c.

Finally, in step S106f, the indexing-time evaluation indicator calculation unit 3131 outputs the indicator value x that has been calculated so far.

Since the higher the similarity between data items, the lower the value of the evaluation indicator in indexing, building a graph-based index 42 based on this value allows creating an edge between data items that have not only a short distance between vectors but also high similarity between attribute values. Further, since the evaluation value is calculated by comparing the attribute values, attribute values of any data type can be evaluated.

### (Index Search Process According to Embodiment 1)

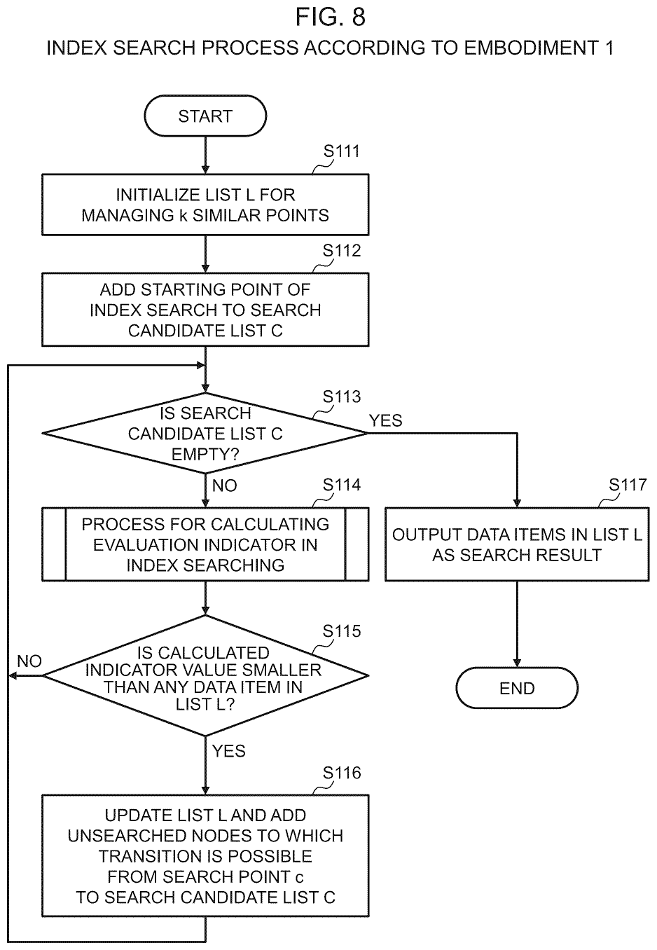

FIG. 8 is a flowchart illustrating an index search process according to the embodiment 1. The index search process according to the embodiment 1 is executed by the index search unit 314 in response to receiving an index search request including specification of the number of top-k search data items via the user terminal 100.

Although the index search process according to the embodiment 1 is assumed to employ NSW and a search algorithm for NSW as in the indexing process, this embodiment can also employ other index structures such as HNSW and search algorithms therefor. For example, since HNSW is hierarchized NSW, it is possible to search a graph-based index based on HNSW by searching the index from the top layer using the index search process shown in FIG. 8, and making a search in subsequent layers in the same way with a neighboring point in the upper layer as the search starting point.

First, in step S111, the index search unit 314 initializes a list L for managing k similar points. However, the number k of elements in the list L is determined based on the number of data items to be acquired given as a query.

Next, in step S112, the index search unit 314 adds a starting point of an index search to a search candidate list C. The search starting point may be either a data item first added to the search candidate list C or a data item located in the center of the vector space 400.

Next, in step S113, the index search unit 314 determines whether the search candidate list C is empty. When the search candidate list C is not empty (NO in step S113), the index search unit 314 advances the process to step S114. On the other hand, when the search candidate list C is empty (YES in step S113), the index search unit 314 advances the process to step S117.

In step S114, the index-search-time evaluation indicator calculation unit 3141 executes a process for calculating an evaluation indicator in index searching in which any data item is retrieved from the search candidate list C as a search point c and an evaluation indicator in index searching for the query qr is calculated. Details of the process for calculating an evaluation indicator in index searching will be described later with reference to FIG. 9.

The search point c selected in step S114 may be either a data item first added to the search candidate list C or a randomly selected data item. However, consider a case of taking into account the nature of the evaluation indicator in index searching that it takes a value equal to or smaller than 1 when the search conditions are satisfied and takes a value larger than 1 when the search conditions are not satisfied. Then, by preferentially evaluating nodes to which a transition has been made from a node with a smaller indicator value, it is possible to exhaustively search for data items satisfying the search conditions at earlier timing. This makes it possible to improve the processing accuracy in the index search process and also increase the processing speed.

Further, the graph-based index 42 in this embodiment has an edge 402 between data items having not only a short distance between vectors but also high similarity between attribute values. For this reason, it has a property that once a data item satisfying the search conditions is reached, it is also possible to exhaustively search for other data items satisfying the search conditions by following the edges of that data item.

In the subsequent step S115, the index search unit 314 determines whether the indicator value of the search point c calculated in step S114 is smaller than the indicator value of any data item in the list L. When the indicator value of the search point c calculated in step S114 is smaller than the indicator value of any data item in the list L (YES in step S115), the index search unit 314 advances the process to step S116. On the other hand, when the indicator value of the search point c calculated in step S114 is larger than the indicator value of any data item in the list L (NO in step S115), the index search unit 314 returns the process to step S113.

In step S116, when the number of elements in the list L is less than k, the index search unit 314 simply adds the search point c, and when the number of elements is k or more, the index search unit 314 replaces the data item having the largest indicator value in the list L with the search point c. Then, the index search unit 314 adds unsearched nodes to which a transition is possible from the search point c to the search candidate list C. Step S116 also allows searching for data items in the vicinity of the search point c. When step S116 is completed, the index search unit 314 returns the process to step S113.

On the other hand, in step S117, since k data items similar to the search point c are stored in the list L, the index search unit 314 outputs these data items as a search result.

The index search process described above extracts one or more data items in the index for which the degree of deviation of a second evaluation indicator based on the query vector from a reference value is ranked in a predetermined place or higher in ascending order in which the degrees of deviation are arranged in order from the smallest to the largest. Note that the reference value is the second evaluation indicator (the evaluation indicator in index searching) when the query vector is the same as a data item in the index.

In this embodiment, the above process devises a search order of the index in consideration of the characteristics of the index and the evaluation indicator, thereby extracting a specified number of data items that are close to the query vector from among data items satisfying the search conditions for the attribute values at high speed and with high accuracy.

### (Process for Calculating Evaluation Indicator in Index Searching According to Embodiment 1)

FIG. 9 is a flowchart illustrating the process for calculating an evaluation indicator in index searching according to the embodiment 1. The process for calculating an evaluation indicator in index searching is a process executed in step S114 (FIG. 8) of the index search process.

First, in step S114a, the index-search-time evaluation indicator calculation unit 3141 initializes the indicator value x at 0. Next, in step S114b, the index-search-time evaluation indicator calculation unit 3141 calculates the distance between the vector given as a query and the search point c selected by the index search unit 314 based on the distance scale that is set from the user terminal 100 as a parameter. The vector given as a query is referred to as a query qr.

The distance calculated in step S114b is a first scale representing the closeness between the query vector and a vectorized unstructured data item associated with one of data items in the index that are the data items included in the index. Then, the index-search-time evaluation indicator calculation unit 3141 normalizes the distance between the vectors of the query qr and the search point c so that the minimum value is 0 and the maximum value is 1, and then adds it to the indicator value x.

Next, in step S114c, the index-search-time evaluation indicator calculation unit 3141 determines whether the values of all attributes for which the search conditions are specified in the query qr have been evaluated. When there is an attribute that has not yet been evaluated (NO in step S114c), the index-search-time evaluation indicator calculation unit 3141 advances the process to step S114d. On the other hand, when all attributes have been evaluated (YES in step S114c), the index-search-time evaluation indicator calculation unit 3141 advances the process to step S114g.

In step S114d, the index-search-time evaluation indicator calculation unit 3141 selects one attribute I to be evaluated from unevaluated attributes. The order of selecting the attributes here does not affect the calculation result of the indicator value x.

Next, in step S114e, the index-search-time evaluation indicator calculation unit 3141 determines whether the value of the attribute I of the search point c selected in step S114b satisfies the search condition specified in the query qr. When the search condition is not satisfied (NO in step S114e), the index-search-time evaluation indicator calculation unit 3141 advances the process to step S114f. On the other hand, when the search condition is satisfied (YES in step S114e), the index-search-time evaluation indicator calculation unit 3141 advances the process to step S114g.

In step S114f, in order to express a penalty for not satisfying the search condition for the attribute I, the index-search-time evaluation indicator calculation unit 3141 adds a weight w_I corresponding to the attribute I to the indicator value x. At this time, the weight w_I added to the indicator value x is a second scale representing the closeness between the search condition and the structured data item associated with a data item in the index. When step S114f is completed, the index-search-time evaluation indicator calculation unit 3141 returns the process to step S114c.

The weight w_I here is a real value larger than 1 passed from the weighting unit 315, and changes the contribution of the attribute I to the indicator value x. That means that the larger the value of the added weight w_I, the more preferentially the search condition for that attribute is evaluated. Since tuning this weight w_I changes the search order of nodes in the index, it affects the processing accuracy and processing time of the index search.

On the other hand, in step S114g, the index-search-time evaluation indicator calculation unit 3141 outputs the indicator value x that has been calculated so far.

The evaluation indicator in index searching is 1 or less when all search conditions for the attribute values are satisfied, and takes a larger value as there are more attribute values that do not satisfy the search conditions. For this reason, the indicator value of the evaluation indicator in index searching makes it possible not only to determine whether each data item satisfies all search conditions, but also to exhaustively search for data items satisfying the search conditions at earlier timing by preferentially searching for data items with a small indicator value of the evaluation indicator in index searching. Further, since the evaluation value is calculated by comparing the attribute values, attribute values of any data type can be evaluated.

### Embodiment 2

An embodiment 2 describes a form in which the index search method in the above embodiment 1 and a conventional index search method are used in combination. In the description of the embodiment 2, differences from the embodiment 1 will be described, and the description that overlaps with the configuration and processing according to the embodiment 1 will be omitted.

### (Indexing Process According to Embodiment 2)

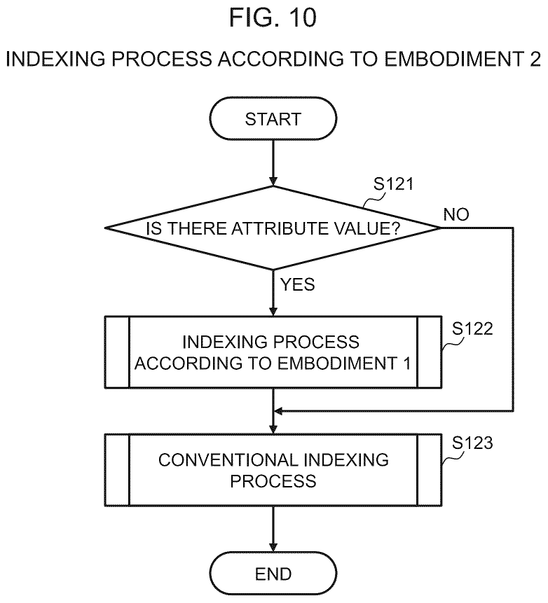

FIG. 10 is a flowchart illustrating an indexing process according to the embodiment 2. The indexing process according to the embodiment 2 is executed by the indexing unit 313 in response to receiving an indexing request via the user terminal 100.

First, in step S121, the indexing unit 313 determines whether an attribute value is present for a target data item. When an attribute value is present for the target data item (YES in step S121), the indexing unit 313 advances the process to step S122, and when no attribute value is present for the target data item (NO in step S121), the indexing unit 313 advances the process to step S123.

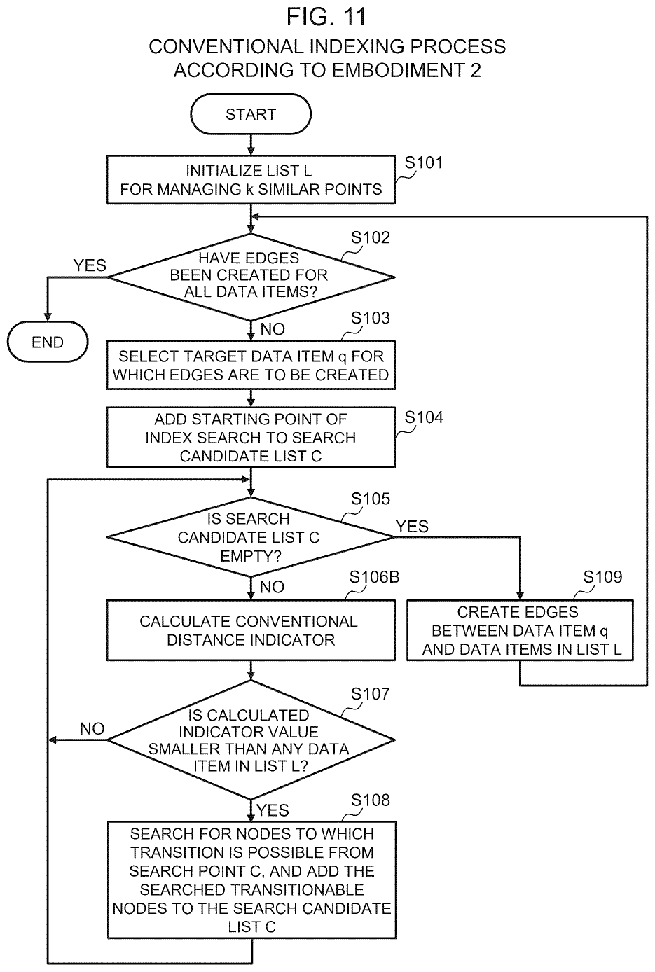

In step S122, the indexing unit 313 executes the indexing process according to the embodiment 1 (FIG. 6). On the other hand, in step S123, the indexing unit 313 executes a conventional indexing process. Details of the conventional indexing process will be described later with reference to FIG. 11.

Note that steps S122 and S123 may be executed in this order sequentially or executed in parallel.

### (Conventional Indexing Process According to Embodiment 2)

FIG. 11 is a flowchart illustrating the conventional indexing process according to the embodiment 2. The conventional indexing process differs from the indexing process according to the embodiment 1 in that step S106B is executed instead of step S106, and they are otherwise the same.

In step S106B, the indexing-time evaluation indicator calculation unit 3131 calculates a conventional distance indicator. That is, the indexing-time evaluation indicator calculation unit 3131 calculates the distance of the vector data item of the target data item as the indicator value of the conventional distance indicator.

### (Index Search Process According to Embodiment 2)

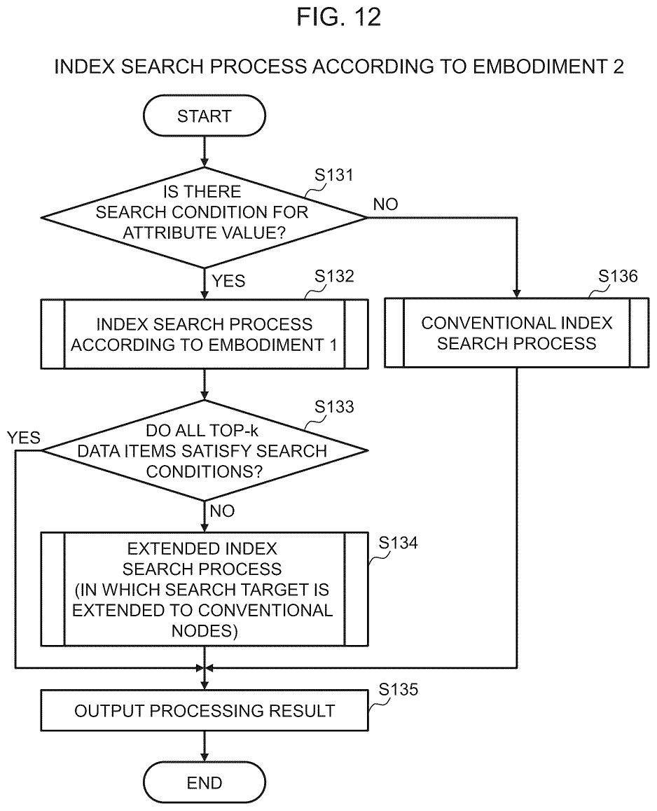

FIG. 12 is a flowchart illustrating an index search process according to the embodiment 2. The index search process according to the embodiment 2 is executed by the index search unit 314 in response to receiving a user instruction including specification of the number of top-k search data items via the user terminal 100.

First, in step S131, the index search unit 314 determines whether given search conditions include a search condition for an attribute value of the target data item. When a search condition for an attribute value of the target data item is included (YES in step S131), the index search unit 314 advances the process to step S132, and when no such search condition is included (NO in step S131), the index search unit 314 advances the process to step S136.

In step S132, the index search unit 314 executes the index search process according to the embodiment 1 (FIG. 8). Next, in step S133, the index search unit 314 determines whether all of the top-k data items searched for in step S132 satisfy the given search conditions. When the top-k data items include a data item that does not satisfy the given search conditions (NO in step S133), the index search unit 314 advances the process to step S134. On the other hand, when all of the top-k data items satisfy the given search conditions (YES in step S133), the index search unit 314 advances the process to step S135.

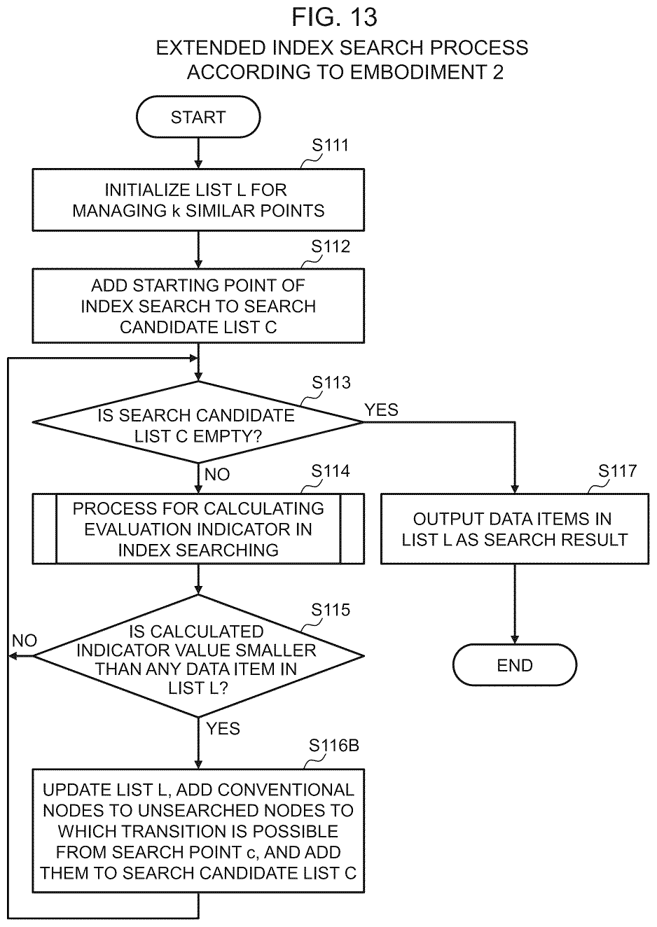

In step S134, the index search unit 314 executes an extended index search process in which the search target is extended to include conventional nodes. Details of the extended index search process will be described later with reference to FIG. 13. When step S134 is completed, the index search unit 314 advances the process to step S135.

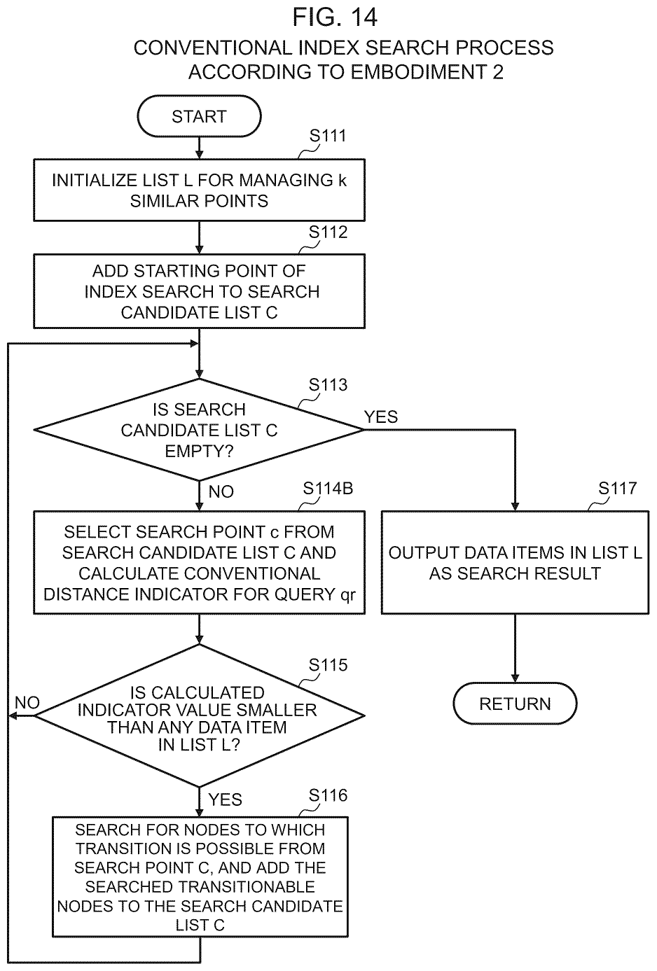

On the other hand, in step S136, the index search unit 314 executes a conventional index search process that is the same as before. Details of the conventional index search process will be described later with reference to FIG. 14. When step S136 is completed, the index search unit 314 advances the process to step S135.

In step S135, the index search unit 314 outputs the search result of step S132, step S134, or step S136 via the output unit of the user terminal 100.

### (Extended Index Search Process According to Embodiment 2)

FIG. 13 is a flowchart illustrating the extended index search process according to the embodiment 2. The extended index search process according to the embodiment 2 differs from the index search process according to the embodiment 1 (FIG. 8) in that step S116B is executed instead of step S116, and they are otherwise the same.

In step S116B, when the number of elements in the list L is less than k, the index search unit 314 simply adds the search point c, and when the number of elements is k or more, the index search unit 314 replaces the data item having the largest indicator value in the list L with the search point c. Then, the index search unit 314 adds conventional nodes to the search candidate list C together with unsearched nodes to which a transition is possible from the search point c. A conventional node is a node 401 to which a transition is determined to be possible based on the distance of the vector data item of the target data item using a conventional method.

### (Conventional Index Search Process According to Embodiment 2)

FIG. 14 is a flowchart illustrating the conventional index search process according to the embodiment 2. The conventional index search process according to the embodiment 2 differs from the index search process according to the embodiment 1 (FIG. 8) in that step S114B is executed instead of step S114, and they are otherwise the same.

In step S114B, the index-search-time evaluation indicator calculation unit 3141 selects a search point c from the search candidate list C and calculates a conventional distance indicator for the query qr. That is, the index-search-time evaluation indicator calculation unit 3141 calculates the distance between the vector data item of the search point c and the query qr as the indicator value of the conventional distance indicator.

The above embodiment 2 appropriately switches between the embodiment 1 and the conventional technique or uses them in combination for the indexing process and the index search process, thereby making it possible to obtain various search results at high speed and with high accuracy compared to using the embodiment 1 or the conventional technique alone.

### Embodiment 3

An embodiment 3 describes the optimization of the weight w_I by the weight optimization unit 3152.

In the above embodiment 1, tuning the weight for each attribute used for calculating the evaluation indicator in indexing and the evaluation indicator in index searching changes the structure of the built graph-based index or the order of searching the index. This greatly affects the processing time and processing accuracy of the indexing process and the index search process.

In the above embodiment 1, the index search is characterized by preferentially searching for data items with a small evaluation indicator in index searching, that is, data items having high similarity to the query vector. This feature makes it possible to transition to data items satisfying the search conditions at early timing by searching a certain path in the graph in a straight line in the early stages of the search as in the depth-first search.

Further, in the index built according to the above embodiment 1, edges are preferentially created between data items with similar attribute values. For this reason, once a transition to a data item satisfying the search conditions can be made, it is possible to transition from the data item to many other data items satisfying the search conditions and to exhaustively search for data items satisfying the search conditions from the middle stage of the search.

From the above, when there is no prior information about the data distribution or query workload, the expected search can be realized by setting all of the above weights to 1.

On the other hand, when there is prior information about the data distribution or query workload, further optimization can be performed. In particular, data management systems such as database management systems (DBMSs) optimize the process by collecting various types of statistical information such as histograms of data distribution and query logs. In view of this, the following describes the optimization of weights based on selection rates for attributes, assuming a situation where statistical information is available.

Here, the selection rate for an attribute is an indicator of how much data is extracted by the search condition for a certain attribute I, and indicates that the lower the selection rate, the smaller the number of extracted data items, that is, the higher the narrowing effect. For example, when all attribute values follow a uniform distribution, the selection rate of the gender attribute having two values: male and female is 1/2, and the selection rate of the prefectural attribute is 1/47.

In the above embodiment 1, by setting a large weight for an attribute with a low selection rate, edges are preferentially created for data items having high similarity of this attribute, and it is possible to exhaustively search for only a very small percentage of data items of all data items at earlier timing. That is, the processing speed and processing accuracy of the search process can be greatly improved.

However, depending on the employed search algorithm of the graph-based index, setting a large weight for an attribute with a low selection rate may deteriorate the processing speed and processing accuracy of the search process.

For example, a graph-based index with a simple structure such as NSW has a problem of large computational complexity for searching for data items located far from the search starting point, that is, data items requiring a large number of hops to transition to the data items.

Therefore, graph-based indexes have a device of intentionally creating edges between distant data items, making it possible to also search for very different data items in a single transition, thereby reducing the average number of hops required for an index search.

Here, in HNSW, by hierarchizing the index, probabilistically selecting some data items from the lower layer data item, and copying them to the upper layer, a coarse-grained graph obtained by thinning out some nodes in the lower layer graph is built in the upper layer. Then, by starting a search from the top layer and using a neighboring point in the upper layer as the search starting point in the lower layer, it is possible to make a search with a coarse grain size in the top layer and gradually with a fine grain size toward the bottom layer, which can accelerate the convergence of the index search process.

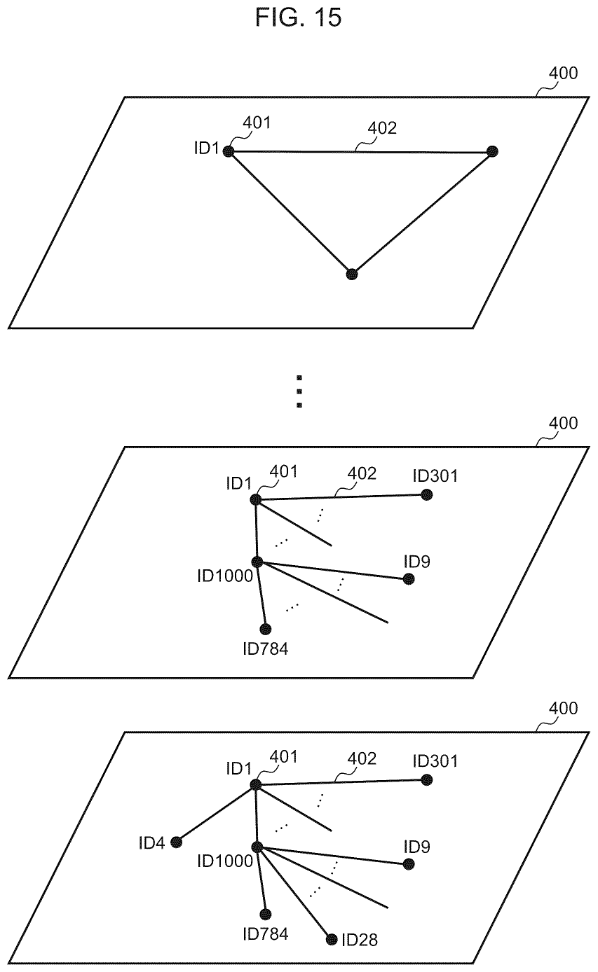

FIG. 15 is a diagram illustrating an example of a graph-based index (HNSW) having a hierarchical structure. There are only three data points (nodes) in the top layer of HNSW shown in FIG. 15, and thus, for example, when the data items have a prefectural attribute, data items satisfying a search condition are present only with a probability of at most 3/47, resulting in disappearance of the narrowing effect with a probability of 44/47. Therefore, in the example in FIG. 15, increasing the weight of the prefectural attribute ends up increasing the number of hops required for searching.

In light of the above, the embodiment 3 describes an example of a weight optimization method considering the selection rates of the attribute values of the data items in the index in the weight optimization unit 3152, the structure of the graph-based index, and the method of searching the graph-based index.

Note that although the embodiment 3 below assumes HNSW as the type of the graph-based index structure, the following discussion can be extended to other types of graph-based index structures and search algorithms for those graph-based index structures according to their respective graph structures.

The data distribution of an attribute I is held as a histogram, and the number of data items included in a bin i is denoted by n_i. For example, in the case of a categorical attribute, each value is allocated to a different bin, and in the case of a numerical attribute, a histogram with equal widths is used to allocate any data item to one of the bins separated at certain intervals.

Further, the probability that a data item included in a bin i is selected by a query is denoted by p_i. However, since p_i is unknown at the time of the initial indexing, p_i=1/|I|, where |I| denotes the number of bins in the histogram. When the index is rebuilt, the p_i is set from the query logs.

The number of nodes present in a layer l is denoted by n_l. However, n_l is calculated from the number of all data items and the sampling probability in the layer l.

At this time, the narrowing effect f_l\hat{ }I(i) of data items included in the bin i of the attribute I in the layer l of the graph-based index in this embodiment is defined as the expression (1). However, the expression (1) is an example of the definition of the narrowing effect f_l\hat{ }I(i) of data items, and another function may be used as long as it is a function satisfying the requirements such as taking the maximum value at n_lp_i=1.

$$\begin{matrix}[ Expression 1 ] & \\ {f}_{l}^{I} ( i ) = \{ \begin{matrix}\frac{{p}_{i}}{{n}_{l} {n}_{i}} & ( {n}_{l} {n}_{i} \geq 1 ) \\ {p}_{i} {n}_{l} {n}_{i} & ( {n}_{l} {n}_{i} < 1 )\end{matrix} & ( 1 )\end{matrix}$$

Further, the narrowing effect F_l\hat{ }I of the attribute I in the layer l is defined as the sum of the narrowing effects of data items included in all bins i as in the expression (2).

$$\begin{matrix}[ Expression 2 ] & \\ {F}_{l}^{I} = {\sum }_{i} {f}_{l}^{I} ( i ) & ( 2 )\end{matrix}$$

On the other hand, the narrowing effect F_I of the attribute I in HNSW is defined as the average value of the narrowing effect of each layer l so that the value does not change significantly depending on the number LL of layers, as in the expression (3).

$$\begin{matrix}[ Expression 3 ] & \\ {F}_{I} = \frac{1}{LL} {\sum }_{l} {F}_{i}^{l} & ( 3 )\end{matrix}$$

Here, since this embodiment allows exhaustively searching for data items satisfying the search conditions at earlier timing by setting the weight w_I of the attribute I to be equal to or larger than 1 as described before, the weight w_I is set as in the expression (4).

$$\begin{matrix}[ Expression 4 ] & \\ {w}_{I} = 1 + {F}^{I} & ( 4 )\end{matrix}$$

The indexing-time evaluation indicator calculation unit 3131 and the index-search-time evaluation indicator calculation unit 3141 calculate the indicator value (the weight w_I) based on the weight w_I determined by the method described above.

### (Weight Optimization Process According to Embodiment 3)

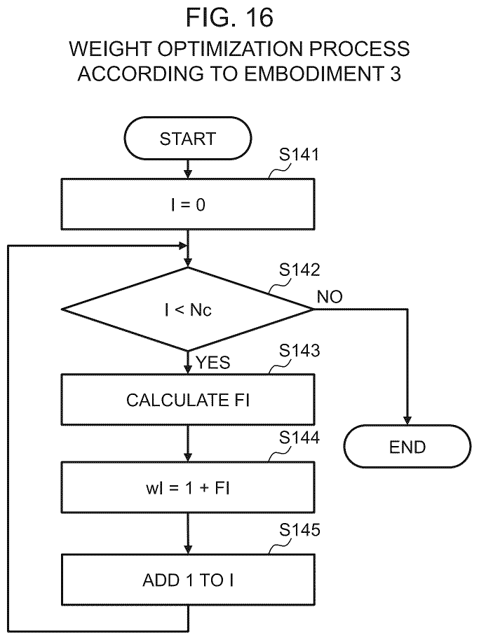

FIG. 16 is a flowchart illustrating a weight optimization process according to the embodiment 3. The weight optimization process is executed by the weight optimization unit 3152 when the weight w_I is not specified by the user.

First, in step S141, the weight optimization unit 3152 initializes the index “I” of the attribute I at 0. Next, in step S142, the weight optimization unit 3152 determines whether the index “I” of the attribute I satisfies I<nc (where nc is the number of attributes). When I<nc is satisfied (YES in step S142), the weight optimization unit 3152 advances the process to step S143, and when it is not satisfied (NO in step S142), the weight optimization unit 3152 ends the weight optimization process.

In step S143, the weight optimization unit 3152 calculates the narrowing effect F_I of the attribute I based on the above expressions (2) and (3). Next, in step S144, the weight optimization unit 3152 calculates the weight w_I based on the above expression (4). When step S144 is completed, the weight optimization unit 3152 advances the process to step S142.

The present invention is not limited to the above embodiments and includes various modifications. For example, the above embodiments have been described in detail in order to explain the present invention in an easily understandable manner, and are not necessarily limited to those including all the described configurations. Further, it is possible to replace part of the configuration of one embodiment with the configuration of another embodiment, and it is also possible to add the configuration of another embodiment to the configuration of one embodiment. Further, it is possible to perform addition of other configurations, deletion, or replacement on a part of the configuration of each embodiment. Further, part or all of the above-described configurations, functions, processing units, processing means, and the like may be implemented in hardware by, for example, designing an integrated circuit.

Further, the configurations, functions, and the like including the units included in the information processing apparatus 1 described above may be implemented in software by a processor interpreting and executing a program that implements the functions. The program is executed by the processor to perform a defined process while using, for example, a storage apparatus and/or an interface apparatus as appropriate. The program may be installed on an apparatus such as a computer from a program source. The program source may be, for example, a recording medium (e.g., a non-transitory recording medium) that can be read by a program distribution server or a computer. With respect to the program, two or more programs may be implemented as one program, or one program may be implemented as two or more programs.

What is claimed is:

1. An information processing apparatus building an index including one or more data items with each of which a vectorized unstructured data item and one or more structured data items are associated,
a processor of the information processing apparatus:
calculating a first scale representing closeness between the vectorized unstructured data item associated with a first data item of the one or more data items and the vectorized unstructured data item associated with a second data item of the one or more data items;
calculating a second scale representing closeness between the one or more structured data items associated with the first data item and the one or more structured data items associated with the second data item;
calculating a first evaluation indicator representing closeness between the first data item and the second data item based on the first scale and the second scale; and
building the index by combining the first data item and the second data item according to the first evaluation indicator.

2. The information processing apparatus according to claim 1, wherein the processor builds the index by combining the first data item with the second data item for which a degree of deviation of the first evaluation indicator based on the first data item from a reference value is ranked in a predetermined place or higher in ascending order of the degree of deviation, wherein the reference value is the first evaluation indicator when the first data item is the same as the second data item.

3. The information processing apparatus according to claim 1, wherein the processor calculates the first evaluation indicator based on the first scale, the second scale, and a weight that changes contribution of the second scale to the first evaluation indicator.

4. The information processing apparatus according to claim 3, wherein the processor determines the weight based on a selection rate representing a probability that each of the one or more structured data items is selected in the second data item.

5. The information processing apparatus according to claim 1, wherein the processor
determines whether the vectorized unstructured data item and the one or more structured data items are associated with each of the one or more data items or only the vectorized unstructured data item is associated with each of the one or more data items and the one or more structured data items are not associated with each of the one or more data items, and
builds the index on a basis of either one or both of the first evaluation indicator based on the first scale and the second scale and the first evaluation indicator based only on the first scale depending on a result of the determination.

6. The information processing apparatus according to claim 1, wherein the processor calculates the first evaluation indicator based on the first scale and the second scale, wherein the first scale is a value obtained by normalizing a distance between a vector associated with the first data item and a vector associated with the second data item as the vectorized unstructured data item, and the second scale is a value obtained by normalizing a distance between one or more attributes associated with the first data item and one or more attributes associated with the second data item as the one or more structured data items.

7. An information processing apparatus storing an index including one or more data items with each of which a vectorized unstructured data item and one or more structured data items are associated,
a processor of the information processing apparatus:
receiving an input including a query vector that gives a condition that the vectorized unstructured data item should satisfy and a search condition that gives a condition that the one or more structured data items should satisfy;
calculating a first scale representing closeness between the query vector and the vectorized unstructured data item associated with one of one or more data items in the index that are the one or more data items included in the index;
calculating a second scale representing closeness between the search condition and the one or more structured data items associated with the data item in the index;
calculating a second evaluation indicator representing closeness between the first scale and the second scale; and
extracting one or more of the one or more data items in the index satisfying the query vector and the search condition according to the second evaluation indicator.

8. The information processing apparatus according to claim 7, wherein the processor extracts one or more of the one or more data items in the index for which a degree of deviation of the second evaluation indicator based on the query vector from a reference value is ranked in a predetermined place or higher in ascending order of the degree of deviation, wherein the reference value is the second evaluation indicator when the query vector is the same as the data item in the index.

9. The information processing apparatus according to claim 7, wherein the processor calculates the second evaluation indicator based on the first scale, the second scale, and a weight that changes contribution of the second scale to the second evaluation indicator.

10. The information processing apparatus according to claim 9, wherein the processor determines the weight based on a selection rate representing a probability that each of the one or more structured data items is selected in the data item in the index.

11. The information processing apparatus according to claim 7, wherein the processor
determines whether the search condition for the one or more structured data items is present, and
extracts one or more of the one or more data items in the index satisfying the query vector and the search condition on a basis of either one or both of the second evaluation indicator based on the first scale and the second scale and the second evaluation indicator based only on the first scale depending on a result of the determination.

12. The information processing apparatus according to claim 7, wherein the processor calculates the second evaluation indicator based on the first scale and the second scale, wherein the first scale is a value obtained by normalizing a distance between a vector associated with the query vector and a vector associated with the data item in the index as the vectorized unstructured data item, and the second scale is a value obtained by normalizing a distance between one or more attributes associated with the search condition and one or more attributes associated with the data item in the index as the one or more structured data items.

13. The information processing apparatus according to claim 10, wherein the processor extracts one or more of the one or more data items in the index satisfying the query vector and the search condition from the one or more data items in the index including a data item to which a transition is determined to be possible on a basis of the second evaluation indicator based only on the first scale when one or more of the one or more data items in the index satisfying the query vector and the search condition cannot be extracted on a basis of the second evaluation indicator based on the first scale and the second scale.

14. An information processing method executed by an information processing apparatus storing an index including one or more data items with each of which a vectorized unstructured data item and one or more structured data items are associated, the information processing method comprising processes of
a processor of the information processing apparatus
receiving an input including a query vector that gives a condition that the vectorized unstructured data item should satisfy and a search condition that gives a condition that the one or more structured data items should satisfy,
calculating a first scale representing closeness between the query vector and the vectorized unstructured data item associated with one of one or more data items in the index that are the one or more data items included in the index,
calculating a second scale representing closeness between the search condition and the one or more structured data items associated with the data item in the index,
calculating a second evaluation indicator representing closeness between the first scale and the second scale, and
extracting one or more of the one or more data items in the index satisfying the query vector and the search condition according to the second evaluation indicator.
